(19) United States
(12) Patent Application Publication
(10) Pub. No.: US 2012/0212005 A1
(43) Pub. Date: Aug. 23, 2012

(54) VisorXtension/VisorX/VX

(76) Inventor: Richard Michael Martinez, Lewisville, TX (US)

(21) Appl. No.: 13/031,642

(22) Filed: Feb. 22, 2011

(51) Int. Cl. B60J 3/02

(52) U.S. Cl. 296/97.6

(57) ABSTRACT

An upholstered sun and glare blocking shield that slides over the factory sun visor, that will adjust easily up and down to 4 inches, will also adjust latterly to 6 inches, dramatically increasing sun visor coverage and giving the driver more comfort and safety as he/she drives in to the sun. With a locking system that prevents unwanted movement.

### BACKGROUND

The present application relates to a protective device from the sun, and more particularly to a sun visor extension, for using in conjunction with the factory sun visor in automobiles and other vehicles.

When people are driving their vehicle in the early morning or in the late afternoon towards the sun, the glare of the sun is severe and annoying. It fatigues the human eyes especially during a long distance drive and becomes a dangerous factor to the driver.

The traditional sun visor of automobile commonly provides a limited level of protection from the sunray in all the position. But it is not effective enough to solve the above glare problem.

In order to reduce the glare of the sunlight, many sun visor extension have been developed over the years.

U.S. Pat. No. 4,058,340 disclosed a sun visor extension that contains a wire frame retainer. It is difficult to be used for different type or shape of sun visor.

U.S. Pat. No. 3,853,370 discloses an attachable visor that is mounted on a clamping assembly which includes too many parts and made this item too complex.

U.S. Pat. No. 4,090,732 discloses a sun visor extension using a pair of tracks and hinges to hold the extension panels which is limited to vertical movement.

U.S. Pat. No. 5,104,174 discloses an expandable covered mirror visor that comprises a retraction means and blades. This device contains so many moving parts that increase tremendously the cost.

U.S. Pat. No. 4,635,995 discloses an attachable sun visor uses a clamping device that is in an U-shape which takes a big space and it would scuff the surface of the sun visor.

U.S. Pat. No. 4,776,628 discloses A shield that may be slidably attached to a sun visor of a vehicle

U.S. Pat. No. 6,231,108 discloses the visor extension includes an elongated substantially flat sleeve

U.S. Pat. No. 7,320,492 discloses A laterally moveable set of sleeves are placed over an existing sun visor

U.S. Pat. No. 6,264,265 discloses A cardboard blank configured for creation of a sun visor extension

U.S. Pat. No. 4,982,992 discloses a glare shield which is clipped on the conventional sun visor. This device comprises too many working parts as well.

### SUMMARY

The present application discloses new approaches to efficiently and dramatically reduce the glare of the sunlight which could blind, irritate and annoy the eyes of the driver and passenger. The approach is to increase the safety and comfort level of driving while keeping cost of manufacturing down, so that the products based on this application would be accessible to everybody. The disclosed innovations of the new, improved and simple sun visor extension system and sun visor extender, in various embodiments, provide one or more of at least the following advantages: Can be used easily and universally for all kind of conventional sun visor of current automobiles, Easy to install over the factory visor of the vehicle easily adjustable and can be also easily used on the side window. A Locking System that tightens the sleeve around the factory sun visor, holding the extension in place, preventing unwanted movement that could obstruct the drivers view.

These advantages of the disclosed inventions will become apparent and understood to those skilled in the art as the description thereof with the reference in the following drawings.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows the sun visor extension unlocked and ready for installation

FIG. 2 shows the sun visor extension bill only

FIG. 3 shows sleeve of sun visor extension only

FIG. 4 shows sun visor extension (VisorX) step 1 of installation on to factory sun visor

FIG. 5 shows sun visor extension (VisorX) step 2 of installation on to factory sun visor

FIG. 6 shows sun visor extension in down position fully extended (down)

FIG. 7 shows sun visor extension (VisorX) in door position fully extended (latterly)

FIG. 8 shows sun visor extension with side view showing Locking System unlocked.

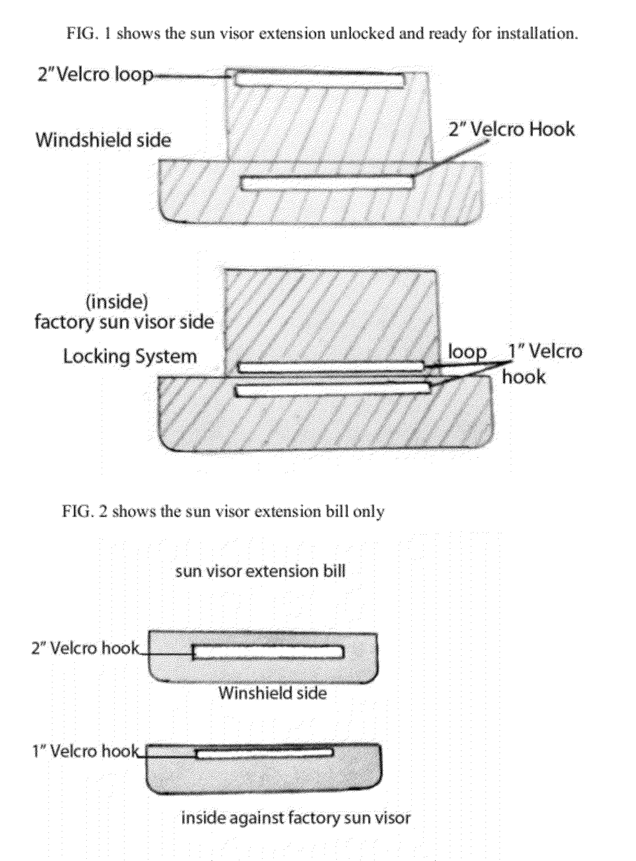

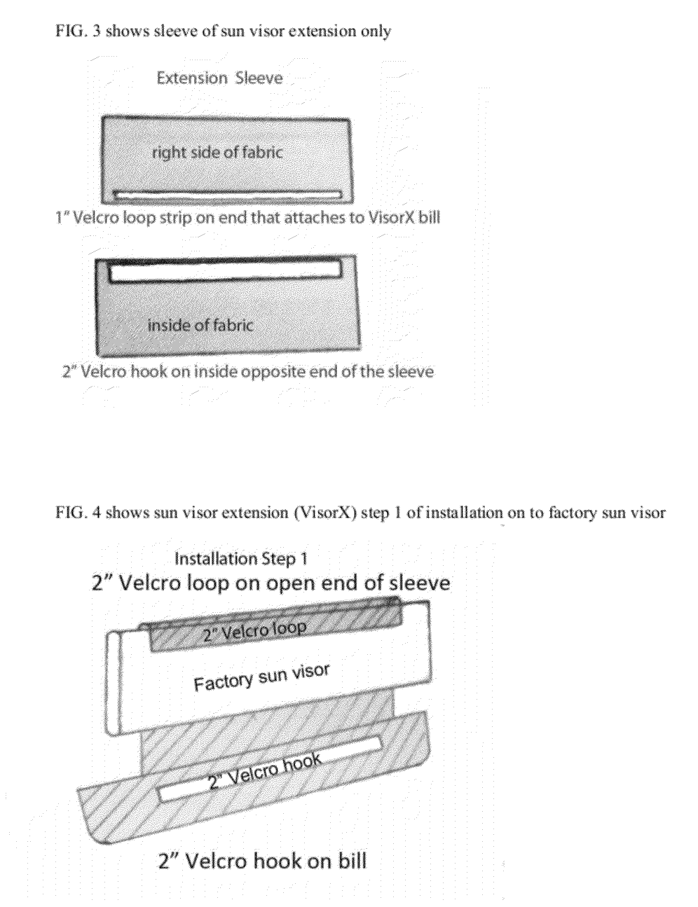

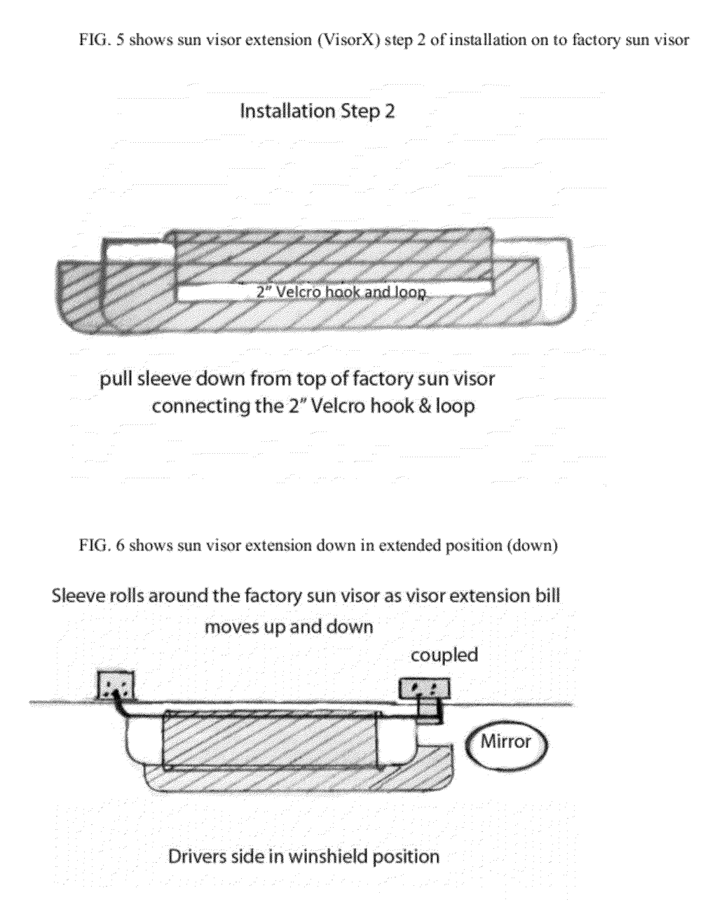

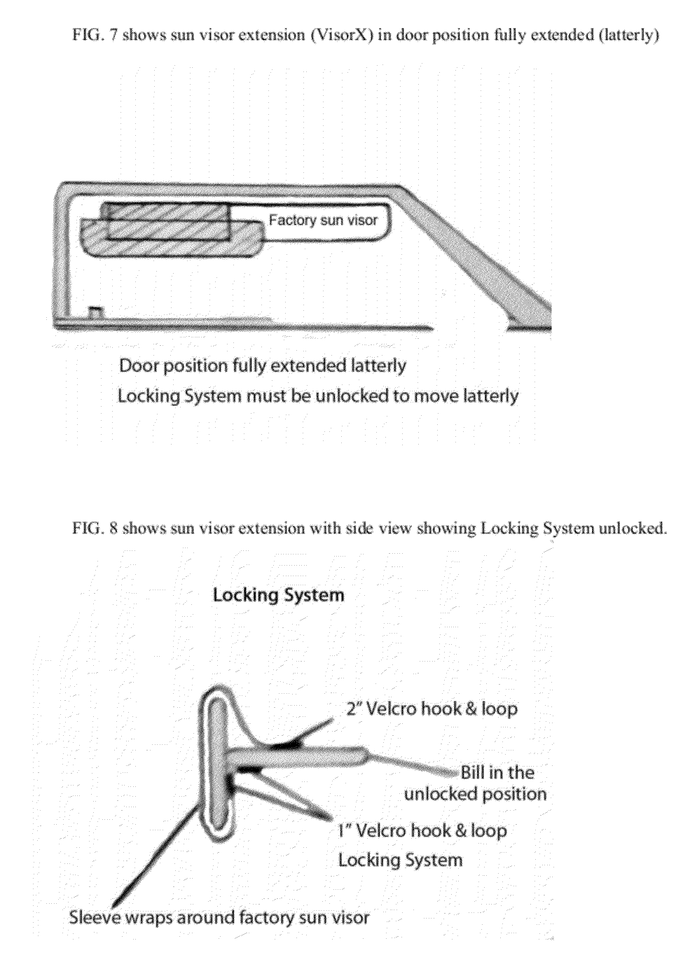

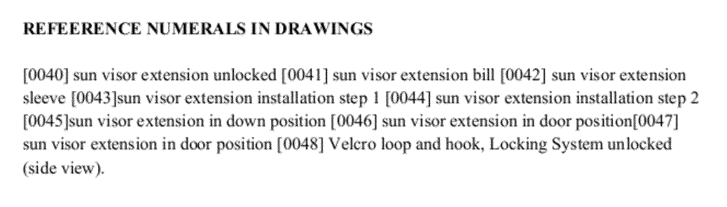

1. An extension for a factory sun visor on motor vehicles, comprising of a) visor bill that blocks the sun, consisting of three layers. Two outer layers of varied fabrics and a center layer of double wall cardboard that gives a rigid body. b) A fabric sleeve that is attached on side with 1″ Velcro loop strip, at the top of the visor bill, left open on opposite end with 2″Velcro loops, sewed on inside of fabric, when installed rolls around the factory sun visor. d) Locking System made with 1″ Velcro loop and hook that tightens the sleeve around the factory sun visor, holding extension in place and prevents unwanted movement that could obstruct the drivers view. e) vanity mirror cutout available by request due to the difference in mirror placement between the auto makers

2. The sun visor extension of claim 1, wherein said extension has no plastic parts to break. Velcro made of plastic but will not break and should last the lifetime of the extension

3. The sun visor extension of claim 1, therein said that extension is fitted over the factory sun visor allowing easy adjustment moving up and down, up to 4 inches.

4. The sun visor extension of claim 1, wherein said extension is fitted over the factory sun visor allowing easy adjustment moving latterly, up to 6 inches.

5. The sun visor extension of claim 1, wherein said extension has no metal parts that could injure the driver, if involved in an accident.

6. The sun visor extension of claim 1, wherein said extension has no plastic or parts that could break and injure the driver, if involved in accident.

7. The sun visor extension of claim 1, wherein said extension has a locking system that tightens the sleeve around the factory sun visor preventing unwanted movement that could obstruct the drivers view.

8. A method for protecting vehicle driver from glare of light, or sun, comprised of. a) Sun visor bill (extension) that blocks the sun, consisting of three layers. Two outer layers of varied fabrics and a center layer of double walled cardboard that gives a rigid body. b) A fabric sleeve that is attached on side with 1″ Velcro loop strip to sun visor bill on one end, left open on opposite end with Velcro loops sewed on inside of fabric, when installed rolls around the factory sun visor. c) Velcro loop and hook that attaches the open end of sleeve to the visor bill. d) Locking System made of 1″Velcro loop and hook that tightens the sleeve around the factory sun visor, holding extension in place and prevents unwanted movement. e) vanity mirror cutout available by request, due to the difference in mirror placement between the auto makers

9. The method of claim 7, wherein said extension increases the coverage of the factory sun visor, protecting driver from blinding sun and light glare.

10. The method of claim 7, wherein said extension should be fully extended down to put factory sun visor into storage position.

11. A method for protecting vehicle drivers from glare of light, comprising the actions of a) sliding the open sleeve over the top of the factory sun visor, (to windshield side of sun visor); b) wrapping sleeve around factory sun visor bringing the visor bill to windshield side of sun visor. c) Line up the bottom of the extension bill with the bottom of the factory sun visor. d) holding the visor bill in place pull the sleeve down and connect the 2″ Velcro loop and hook. e) With three fingers pull extension down to effective position to block glare. f) Flip visor bill up and away from factory sun visor to adjust latterly and return bill to lock position, g) all one piece, no parts to loose.
